(19) United States
(12) Patent Application Publication
(10) Pub. No.: US 2009/0248524 A1
(43) Pub. Date: Oct. 1, 2009

(54) Systems, methods and apparatus for the display of advertisements in a software application

(76) Inventors: Jonathan Defoy, Brossard (CA); Bruno Goulet, Brossard (CA)

Correspondence Address: Biztree Inc, 555 Rene-Levesque West, Suite 1500, Montreal, QC, H2Z 1B1, CA

(21) Appl. No.: 12/412,274

(22) Filed: Mar. 26, 2009

Related U.S. Application Data
(60) Provisional application No. 61/039,757, filed on Mar. 26, 2008.

(51) Int. Cl. G06Q 30/00; G06F 17/00; G06F 17/30; G06F 9/44; G06F 15/16

(52) U.S. Cl. 705/14.1; 705/14.41; 705/14.66; 705/14.68; 705/14.69; 705/14.72; 705/14.73; 715/234; 707/3; 717/168; 709/206; 707/E17.014

(57) ABSTRACT

Systems, methods and apparatus facilitating the display of advertisements in a software application in general, but more particularly in a computer program permitting people to write, edit or view digital documents, hereafter referred to as “Document Templates Software”. Advertisements shown to users can be targeted based on user profile and document properties. In one embodiment, a Document Templates Software can embed an office suite application (such as Microsoft Office, Corel WordPerfect Office or OpenOffice.org). In a second embodiment, the Document Templates Software can also function as a stand-alone application that incorporates a built-in document editor module. In a third embodiment, the Document Templates Software can be a plug-in to an office suite application. Finally, in a fourth embodiment, an office suite application could comprise a built-in Document Templates Software module or feature.

### CROSS-REFERENCE TO RELATED APPLICATIONS

Provisional utility patent application no. 61039757

### BACKGROUND OF THE INVENTION

### Field of the Invention

The present invention relates to the distribution of ad-supported software in general, and more particularly, to methods, systems and apparatus permitting the display of advertisements in a Document Templates Software while a user is editing or viewing digital documents.

With the advent of modern computing and the growing adoption of personal computers in the last 3 decades, digital documents are now widely spread (much more than their paper counterpart) as they can be more easily accessed, edited and archived. In order to create a digital document, depending on the nature and format of the document to be created, a computer user must use one of the following computer programs: a word processor (e.g. Microsoft Word), a spreadsheet application (e.g. Microsoft Excel), a presentation application (e.g. Microsoft PowerPoint), a database application (e.g. Microsoft Access) or a graphics suite (e.g. Microsoft Publisher).

These applications constitute what is known as an office suite, sometimes called an office software suite or productivity suite. Office suites like Microsoft Office, Corel WordPerfect Office, OpenOffice.org and others have been on the market since personal computers became popular consumer products. Along with Internet browsers (Internet Explorer, FireFox, etc.) and email communication software (Outlook, Eudora, Lotus Notes, etc.) the office suite remains one of the most used programs as it has a variety of uses and applications within the business world, academia and the home.

While the applications that are included in an office suite allow a computer user to write digital documents much more efficiently than by hand, they lack advanced functions that further automate and facilitate document writing; one of the most painful and time-consuming activities people face today. The difficulties encountered in the writing process become especially clear when writing complex documents such as contracts, agreements or financial spreadsheets.

This invention relates to computer programs and systems for providing office suite users with more advanced features and additional functionalities to increase productivity and reduce time and effort associated with document writing. It enables computer users to partially automate the writing of documents by accessing a large library of document templates and by using the automated insertion of pre-written text, language mapping, a writing tips wizard and other functionalities. Although very useful, such a computer program can be difficult to commercialize on a massive scale; it does not possess any brand recognition compared to mainstream office suite software it complements, which implies that the cost of marketing would very likely be equal or superior to the price it can be sold for.

There are high chances that a poor business model will prevent this useful computer program from being used by a large number of people. Therefore, an ad-supported business model in which the application is free and the software developer is compensated by advertisers paying to display their targeted advertisements to office suite users is needed to ensure a mass distribution of this invention.

Since the advent of the World Wide Web some 18 years ago, several methods and systems have been developed to display targeted advertising to computer users; some ended up as total failures while others became major successes. Users' overexposure to banner ads, which can now be labeled as “traditional” Internet display advertising, has substantially reduced the efficiency of these advertisements. That is why in recent years new ad formats such as rich media, video and roll-over ads have started to appear on the market. While this is a step in the right direction to increase efficiency of online advertising, it won't suffice since computer users have put themselves in a mindset where they don't pay attention to the ads anymore. Therefore, there is a need for a new, more efficient online advertising channel.

This invention also relates to methods and systems to display advertisements while a computer user writes, edits, or views a digital document. Not only do users spend a lot of time working in digital documents (office suite environment) on a daily basis but this is also a contextual environment where they are captive. Moreover, since users are not currently bombarded with advertisements displayed in office suite software, this makes this “exclusive” new advertising channel particularly effective.

Furthermore, in the last 2 years or so PC monitor manufacturers have started to push new monitor sizes; they have replaced the old ¾ screen size by the new 16/9 wide screen size (exactly like old TV sets have been replaced by digital wide screens). As a result, computer users now have much more “unused space” on their screen while using their office suite software applications. Therefore it is possible to display non-intrusive, contextually relevant advertisements in this unused space without negatively impacting the user experience.

The discussion above only constitutes general background information. This information is not intended and should not be used, to determine the full scope of the claimed subject matter.

### BRIEF SUMMARY OF THE INVENTION

It is an objective of this invention to provide methods and systems using software applications to enhance the utility of office suite programs by providing pre-written content in the form of document templates and other useful functionalities that facilitate the writing of any digital document.

Another objective of the present invention is to provide methods and systems to facilitate the rapid adoption and frequent use of a software application, more specifically of a Document Templates Software. The best way to do so is to offer the software application for free to the end-user. In order to compensate the software publisher, such software is supported by paid advertisements. The value provided to office suite users creates a fair trade-off to users who will be shown advertisements while they work in digital documents.

Another objective of the present invention is to provide methods and systems to display targeted, contextually relevant advertisements to computer users while they are writing, editing, or viewing any digital document. With larger computer screens now becoming the norm on the market, advertisers will appreciate a new and efficient online advertising channel that does not negatively affect the user experience.

Finally, another objective of the present invention is to provide methods and systems to facilitate the display advertising in any software application, including in a software installer, to help people monetize the distribution of free software programs while providing advertisers with a new type of advertising media that we call “in-software advertising”.

This Summary is only provided to present a few selected concepts in a simplified form. This Summary is not intended to identify key features or essential features of the claimed subject matter, nor is it intended for use as an aid in determining the scope of the claimed subject matter. The claimed subject matter is not limited to implementations that solve any or all disadvantages noted in the background.

### BRIEF DESCRIPTION OF THE DRAWINGS

The above-mentioned systems, features, methods and objects of the present invention will become more apparent with reference to the following descriptions taken in conjunction with the accompanying drawings.

FIG. 1 illustrates a typical document template software interface with different functions and available spaces where advertisements can be displayed to the user.

FIG. 2 illustrates and compares the four (4) possible embodiments of the present invention. More specifically, FIG. 2A shows a document template software embedding an Office suite, FIG. 2B shows a document template software with a built-in document editor/viewer, FIG. 2C shows a document template software as a plug-in to an Office suite and, FIG. 2D shows an Office suite with a built-in document template software. Those skilled in the art will recognize that a plug-in or add-in is an additional piece of software that is installed as an extension to a software application, which constitutes the main difference between embodiments 2C and 2D.

FIG. 3 illustrates the different advertising channels available to advertisers to display advertisements (in different possible formats) to users through the advertising platform.

FIG. 4 illustrates the different components of the in-software advertising platform and how those components interact together by communicating through an Internet connection.

FIG. 5 illustrates the sponsored downloads ad serving process used by the advertising platform.

FIG. 6 illustrates the ad targeting and ad serving methods.

FIG. 7 illustrates how the Ad server determines what sponsors ads are assigned and displayed to the user on the download site.

FIG. 8 illustrates how the sponsors ads assigned to the user on the download site are communicated to the software installer executable to maintain consistency throughout the complete user experience with the software application.

FIG. 9 illustrates a typical download website displaying sponsors ads the user sees while he/she comes on the site to download the software application

FIG. 10 illustrates a software installer executable and download website exhibiting the same sponsors ads that are assigned by the Ad server (ref to FIG. 7 and FIG. 8).

FIG. 11 illustrates a software installer executable displaying newsletters subscription listings.

FIG. 12 illustrates a software installer executable containing video advertisements.

FIG. 13 illustrates a typical document template software home page with sponsors' logos positioning.

FIG. 14 illustrate an example of some in-software advertising ad targeting options.

### DETAILED DESCRIPTION OF THE INVENTION

### Copyright Notice

A portion of the disclosure of this patent document contains confidential material which is subject to copyright protection. The copyright owner has no objection to the facsimile reproduction of any of the patent document as it appears in the USPTO patent file or records but otherwise reserves all copyright rights whatsoever.

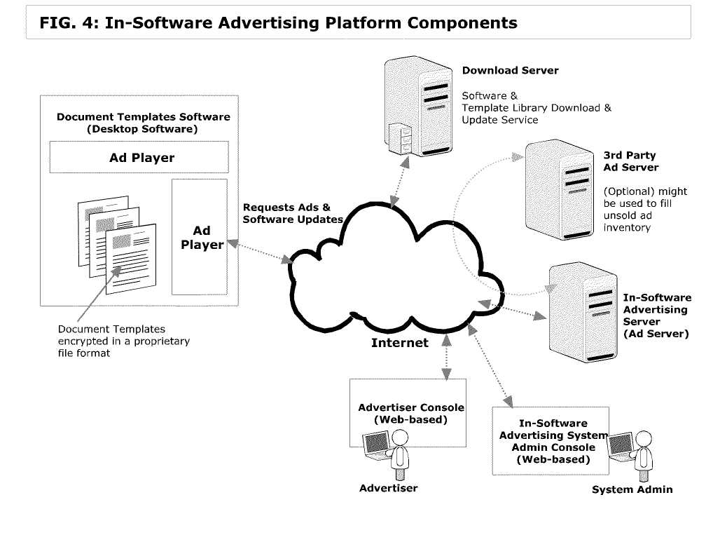

Inventors have recognized that there is a need for systems and methods that facilitate or otherwise allow a software publisher to include advertisements in a software title to monetize the distribution of a software application (FIG. 4). Inventors have also recognized that advertisers are looking for advertising channels providing them a better return on investment, that are highly targeted and highly engaging for their potential clients. Furthermore, Inventors have recognized that people spend a lot of time manipulating digital documents using office productivity suite and that he who could monetize this “air-time” would most probably generate substantial revenues. To further explain this invention, we are going to use the example of an ad-funded Document Templates Software that would be distributed for free to the users.

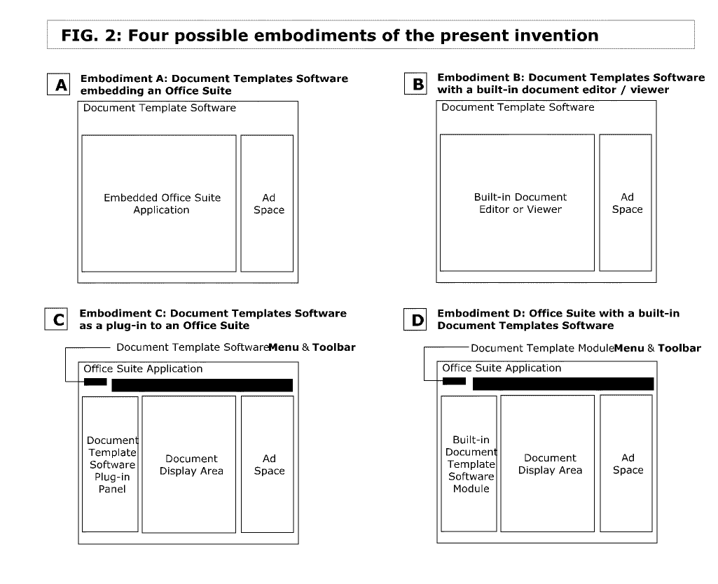

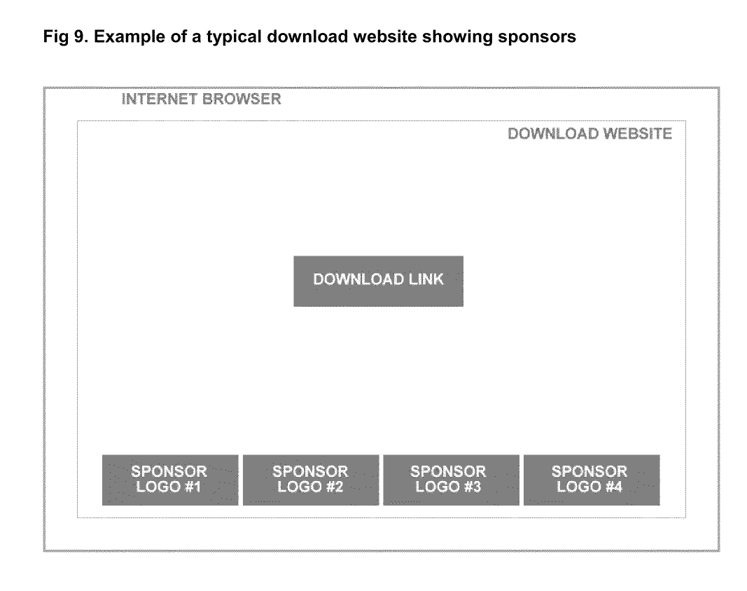

Users first come into contact with the Document Templates Software (FIG. 2) via a download website (FIG. 9). They are presented with a product description and download link to download and install the software for free. The logos of several third party advertisers are also present on the site. Advertisers are given the role of sponsors via a text mention that tells users that the Document Templates Software is given to them for free thanks to these advertisers (sponsors).

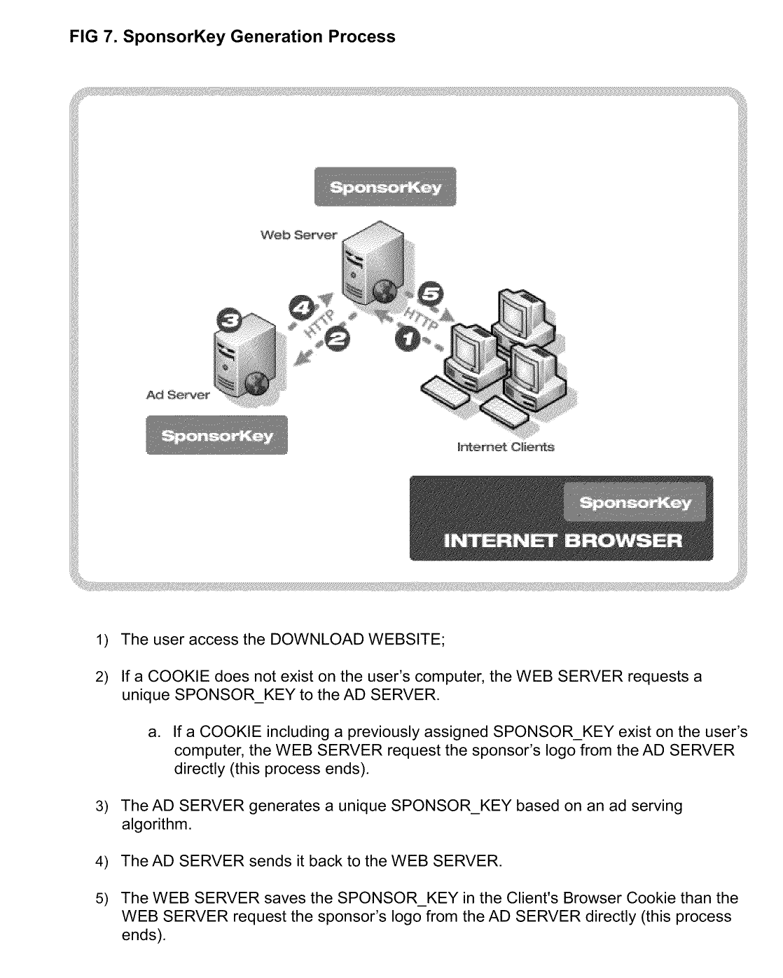

Technically, the download site includes computer code that requests a number of advertisers' logos to be displayed from an Ad Server through the Internet. On a user's first visit to the download site, the Ad Server selects only a subset (1 to 10 ads) to be displayed from its large pool of advertisers. The server ad selection mechanism can be configured to be done on a first come first serve basis (until an advertiser's budget is exhausted), to proportionally distribute advertising opportunities according to the budget of each advertiser or provide advertising placement to the highest paying advertiser. The advertisers whose logos are displayed to a specific user who visited the website for the first-time will be tagged to that user with a browser cookie. This SponsorKey tag will cause the specific ads displayed on the user's first visit to be shown to this user every time he/she comes back to the website in the future. The way this works is that before requesting new sponsors from the Ad Server, the computer code implemented in the download website will look for the presence of such a SponsorKey. If a SponsorKey is found, it will be added to the ad request made to the server, which in this case would return the logos of the advertisers identified by the SponsorKey. This process is illustrated by FIG. 7.

The Sponsored Downloads ad serving algorithm also takes into account that some of the sponsors may be competitors and that they would definitely not appreciate to have their ads shown side-by-side. To accommodate this, we introduced the “sponsor category” feature. Each advertiser is associated with one or more categories, according to their product/service nature, for example, banking, mobile phone services, computers, etc. If at least one of the associated categories of two advertisers matches, these two advertisers are considered as competitors. During the process of choosing ads for exposure, the system will make sure that no two competitors' ads are shown together.

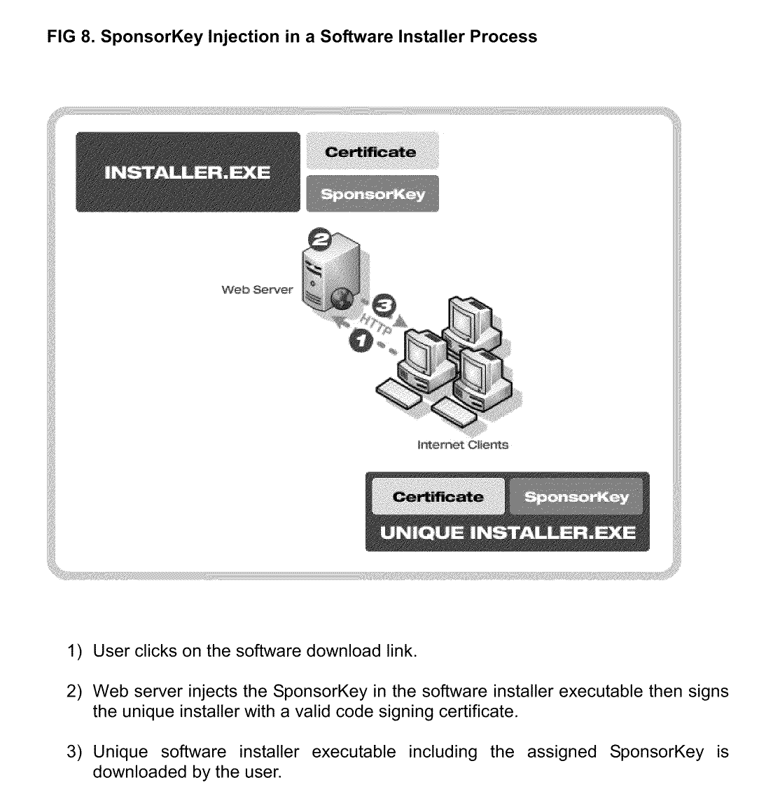

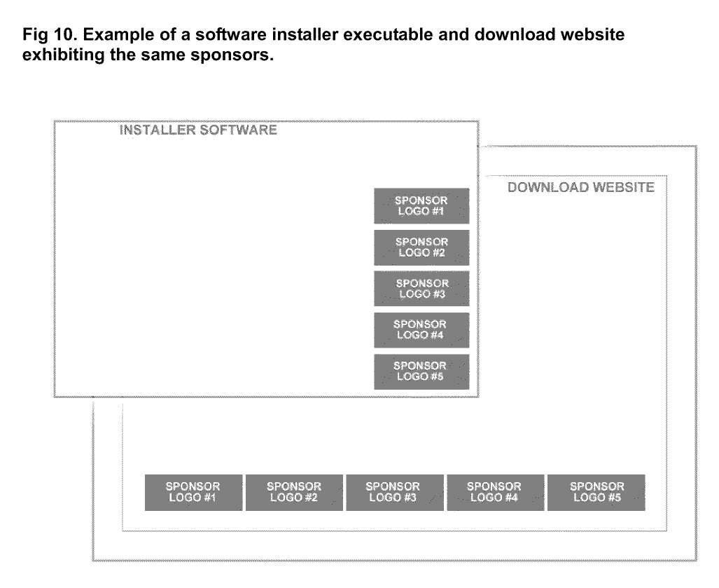

Once the user clicks on the download link, a computer code element will inject the SponsorKey in the software installer executable then sign the executable with a valid code signing certificate (FIG. 8). Then, the software installer executable is downloaded by the user. The user subsequently executes (runs) this executable to launch the installation of the Document Templates Software. This installation initiates standard file download, extraction and copying processes, as well as the request to the Ad Server for the sponsors' logos (or advertisements) matching the SponsorKey, which are shown in the installation window (FIG. 10) and take the form of advertiser logos or advertiser image/text ads.

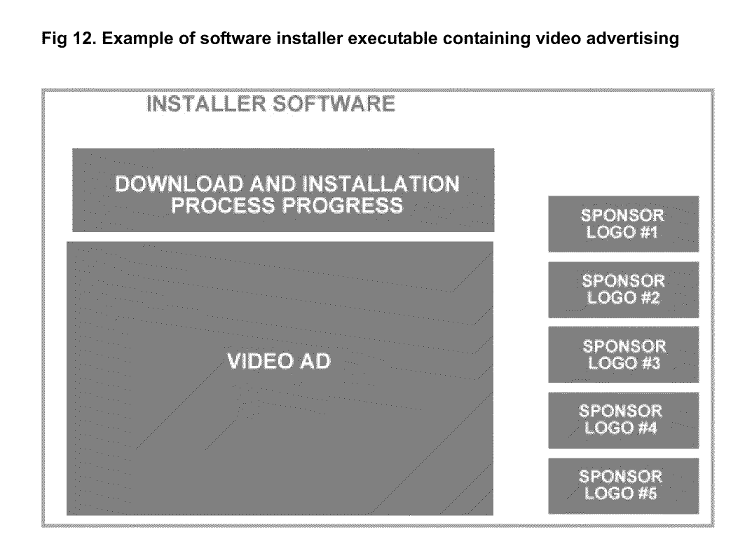

During the installation process waiting time (download and installation process), the user might be presented video/audio advertisements (FIG. 12). The video/audio advertisements are requested to an Ad Server by an Ad Player component (typically a flash player, a Windows media component or the like). The Ad Server can return one or many files to be played in a play list. Once a video/audio advertisement has been played, the Ad Player will send a callback request to the Ad Server to confirm that the ad has been fully delivered. Optionally, the video/audio ads played can be force-fed to the user, i.e. the user will need to complete the view of the advertisements before the installation ends. In this case, the installer will not provide the user with a “run software” option until all predetermined video/audio ads have been played in their entirety. When all ads are played, the Ad Player makes a “callback” to the software installer and the executable will then enable the “run software” option. The Ad Server also has the ability of displaying only the videos/audios that belong to the sponsors that were tagged to a user or the messages of any other advertiser that has supplied its advertisements to the Ad Server.

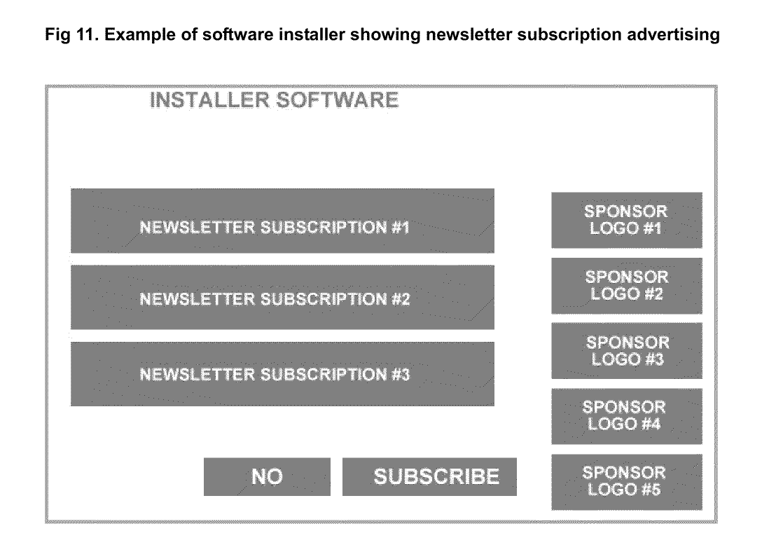

The software installer executable can also feature advertiser newsletters listings that allow users to subscribe to email newsletters (FIG. 11). Those newsletters listing are requested by the Ad Player component, element or software code to the Ad Server. The server returns an XML file containing the newsletters information. The Ad Player can be configured to set the desired number of newsletters listings from the Ad Server. The Ad Server selects the highest paying newsletters available for the specific software title. Advertisers are charged a cost-per-subscriber fee that they can determine in their advertiser console.

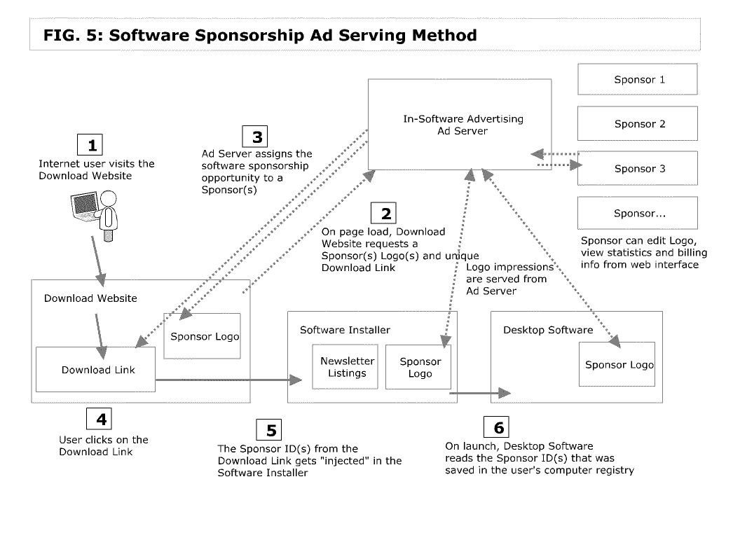

Once the installation process is completed and a user clicks on “run software” or a close button, the software installer executable will save the SponsorKey in the user's computer registry. This tagging method ensures that every time the user will run the software in the future, the ads of these specific sponsors that were displayed during the installation will continue to be exposed to this user in key areas of the software (FIG. 5).

The advertisers whose logos were displayed on the site when a user initiated the download process are able to keep count of the number of users that have being exposed to their ads through a dedicated advertiser console. This console also provides real time data reflecting the number of times their ads (logos, images, texts, videos, newsletters and other formats detailed below) have been shown and clicked on by users on the website, in the software installation and inside the Document Templates Software. The console also allows advertisers to control whether their ads are shown or not (paused), and in which geographic region and language their logo may be shown to a user.

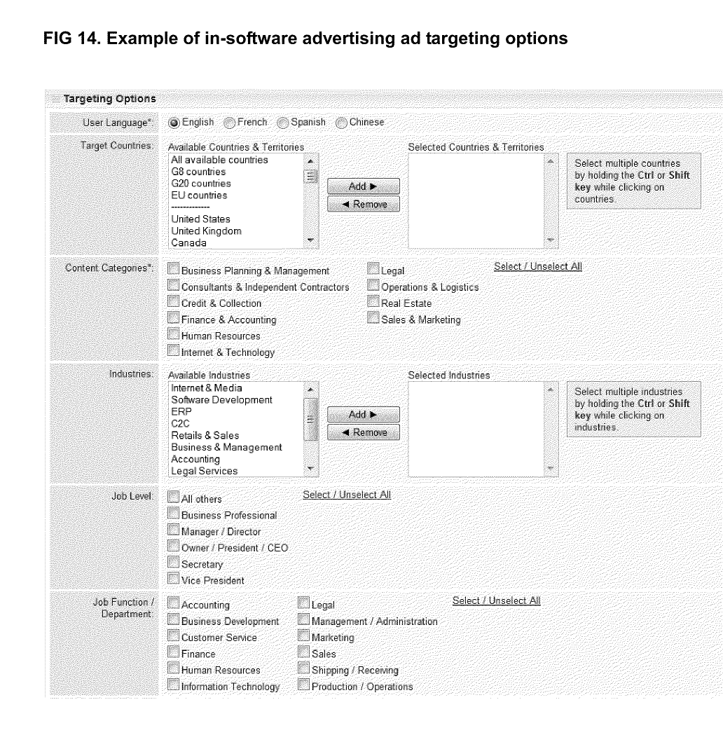

For certain ad types, the Advertiser Console provides targeting options that allow an Advertiser to select the gender, job title, industry, and country of the users who will be shown an advertisement (FIG. 14).

The first time a user runs the software, he/she will be asked to create a profile along with unique login information (username and password) that will allow the user to use the software and sign in to a web authentication system. The user can choose to sign in manually by entering his/her username and password in a dedicated area of the software login screen upon every software session or the user may select a “sign me in automatically” option that will automatically pass the username/password information to the authentication system upon every software session.

The profile created upon the user's first software session and which can be modified at a later time by the user is used to automatically fill data into relevant documents (via the AutoFill software function) and to provide advertisers with ad targeting variables. The information that makes up a user profile includes, but is not limited to, user's name, gender, address, job title, company industry, company size, language preference and certain preferences, interests or inclinations pertaining to the potential purchase of certain products or services.

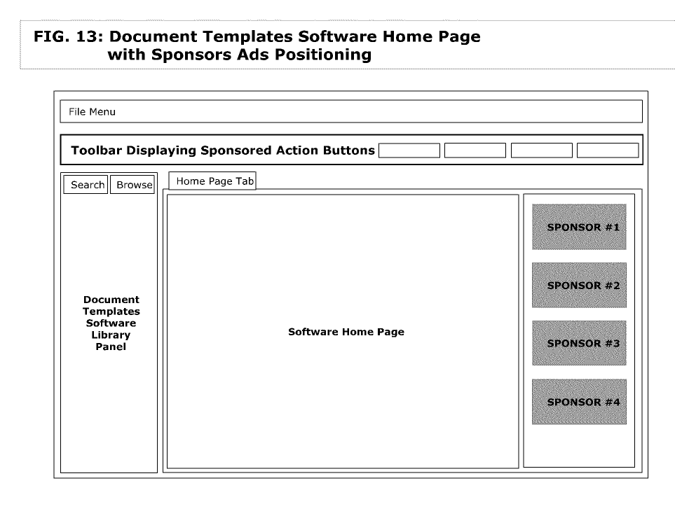

Inside the software, the initial central module shown to the user is the Software Home Page which can be either programmed in the software code or a webpage that loads in a web browser that is integrated or provided with the Document Templates Software. This home page contains the ads and/or logos of the advertisers that were tagged to this user during the download process (FIG. 13). Those ads are delivered from the internet Ad Server. When a user clicks on an ad, a new browser opens at the URL specified by the Advertiser, either within the software or outside the software using the user's preferred browser application.

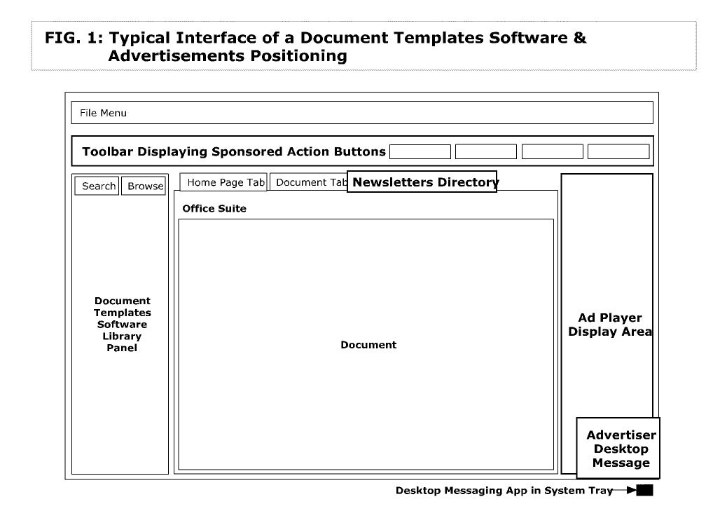

In this Document Templates Software, alongside the main document viewing area (or in any other predominant location of the main software interface), banner ads called Side Ads are shown to users in a dedicated ad display panel (Ad Player) that incorporates a web browser component (FIG. 1). This ad space (or ad inventory) can be either exclusive or non-exclusive to the specific advertisers that were tagged to this user upon installation. When a user clicks on a Side Ad, a browser window opens at the URL specified by the advertiser, either within the software as a new tab or outside the software using the user's preferred browser application. In another embodiment, the Side Ad browser can also be extended to become a full screen browser itself, which may help solve some pop-up blocker issues.

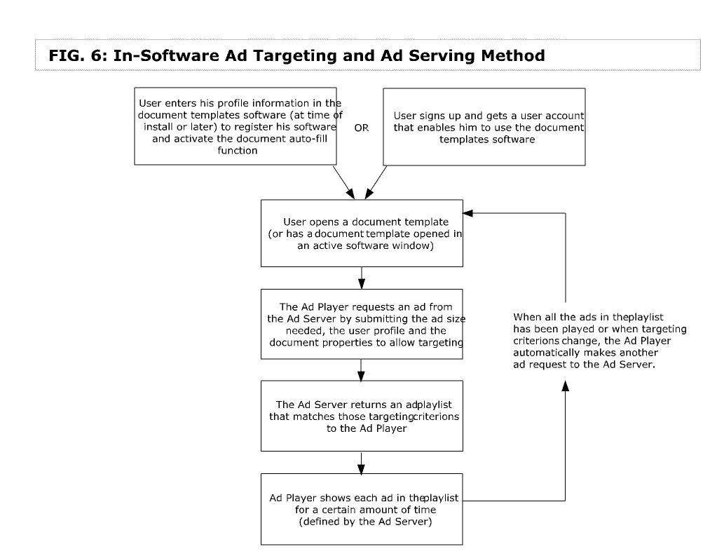

The ads displayed in the Side Ads space are delivered by an online Ad Server. Once the user opens a document, the Ad Player makes an ad request to the server which includes the user profile and the document properties to allow ad targeting (FIG. 6). The Ad Server then returns a play list including a number of ads that should be played in the next 30 minutes (this value can be configured). While the user is viewing or editing a document, the Ad Player will automatically rotate the ads shown in the Side Ads area every minute (this value can be configured). In the event that no user activity (mouse movement or keyboard input) is detected within in a determined period of time, the Ad Player will stop automatically rotating the ads until the user becomes active again. This additional business logic helps prevent the serving of ads to users that are either away from their desk, busy with something else or probably not very attentive to the current advertiser's advertisement. All ad impressions and ad clicks are reported to the Ad Server in real-time via the Internet.

The Ad Server algorithm has the capacity to dynamically inform the Ad Player of the speed at which ads should be rotated. In the event that the server ad inventory is greater or equal to the “air-time” generated by the users of the Document Templates Software, the ads would rotate at the normal interval of let say, one minute. In the event the ad inventory is less than the “air-time” available for ads (in the case of unsold ad inventory) the Ad Server could for example request the Ad Player to play ads at an interval of 2 minutes. This would have the effect of automatically passing more value to the advertisers using the system in situations where anyway, there would be a lack of available ads to display. To communicate this info, the Ad Server simply included fewer ads in the playlist which is normally supposed to be played in 30 minutes (in this example). So, a playlist with 30 ads is read by the Ad Played as 30 minutes divided by 30 ads equal 1 minute per ad and a playlist with 10 ads is read by the Ad Played as 30 minutes divided by 10 ads equal 3 minutes per advertisement.

The variety and increasingly larger sizes of computer monitors has resulted in wide differences in the space available to display a software application on the screen of a computer user. The Ad Player or a computer implemented piece of code would contain an algorithm permitting to automatically adjust the ad space according to the user's screen size. This component has been developed to maximize the advertising revenue generated from displaying advertisements in software by detecting the amount of available or unused space on a user's screen that can be utilized to display advertisements and therefore serve varying sizes or amounts of ads to the user depending on the space thus calculated.

The algorithm will, for example, detect the screen resolution of a user to be 1024×768 pixels and therefore serve this user an ad of standard size (e.g. 120×600 skyscraper). If the algorithm detects a resolution of 1680×1050, it will recognize that a larger amount of software space remains unused by the software and will therefore serve the user a larger ad (e.g. 160×600 wide skyscraper) and/or additional ads. The algorithm has also been conceived to ensure that a user's screen is not over saturated with ads; that is to say it will serve smaller ads to a user who has a lesser amount of unused space on his/her screen. It has also been conceived to maximize advertising revenues for the software publisher.

The upper toolbar band of the software contains several buttons for which the text label and display icon are provided by advertisers in their account console (FIG. 1). When users click on these Toolbar Buttons, a web page opens inside the software at the URL that is designated by the advertiser that “owns” the button in question. Like Side Ads, these Toolbar Buttons (label, icon and URL) belong to the specific advertisers that were tagged to this user as well as several other advertisers that purchase ad impressions (or clicks).

The display of ads and the tabulation of statistical data pertaining to their impressions, clicks and click-through rates are managed through the Ad Server and Advertiser Console. The Ad Server operates the algorithm that selects the Toolbar Buttons to be displayed according to advertisers' budget, targeting options and cost-per-click or CPM bids. Advertisers can control all those variables from their management console. They can also upload ads, review ad performance and costs, as well as suspend or resume the display of their ads.

An additional component of the Document Templates Software allows advertisers to show short text or image messages to users on their desktop in a dedicated “messenger” style window (FIG. 1). Provided the user has elected to receive such messages via his/her preference settings inside the software, the user will see a small window rising in the lower right-hand side of his/her desktop when an Advertiser's approved message is delivered according to the airing schedule established by the ad delivery system. When a user clicks on the Desktop Message a browser window opens at the URL specified by the Advertiser. As with the other ads, Advertisers are able to schedule and create ads, and review their performance, via the Advertiser Console.

Given that different ads are shown to users based on the variables in their profile and different software contexts (e.g. document category being viewed by user), we have developed a way to ensure that the ad targeting (matching an ad with a user profile and/or software context) chosen by an advertiser remains accurate throughout a user session in the software and especially when a user changes variables in his/her profile. This process is called ad retargeting. If for example a user modifies his/her industry type or location in his/her profile, the new or updated profile data will be sent to the Ad Server which will then reassign a new playlist to the Ad Player.

This ad retargeting also takes into account a user's interaction with an ad (such as the number of clicks and impressions this user has generated or witnessed), as well as a user's feedback submitted about a specific ad while that ad is being shown. If for example a user has viewed a proportionally large number of impressions of a specific ad (or category of ads) but has never clicked on it, the Ad Server may decide, based on pre-established rules, not to show that ad (or type of ads) to that user again or diminish the amount of impressions of that ad (or type of ads). Similarly, if a user negatively reviews an ad, the Ad Server will reduce or stop the display of that ad to the user in the future.

Ad retargeting is also taking place if a document is opened or closed in the software. If it detects a document is open it will pass on the document category ID to the Ad Server to include this variable as an available targeting variable. Therefore if an advertiser has selected to show its ads only to users of profile X while a category A document is open then its ads will only be shown to users that have a profile X and that are viewing a document of category A. If this same user closes that document and opens a document of category B, the ad will no longer be shown to this user since the advertiser has targeted its ad exclusively to documents of category B.

Referring to claim 28, each document consists of a container object which is encrypted using Microsoft Cryptography API. Files are mainly composed of 2 parts, the Header and the Data. The Header part contains details about the source file extension (.doc, xls, .pdf, etc), document name, document keywords, document category, document type, access rights (FreeDoc, PremiumDoc, etc.) and header version info. The Data part contains the native binary content of the encapsulated file.

Each file is encrypted/decrypted using Microsoft Cryptography API which provides services to enable the client software to use cryptography to read and save encrypted documents. In an implementation of this invention, someone could use for example the RSA:MD5 algorithm with DES (sourcephrase and passphrase protection). Other encryption technology could also be used in a similar implementation.

Referring to claim 30, one of the objectives is to force the users of the ad-supported version of the Document Templates Software to actually need to use the software to view and edit the various document templates provided with it. To enforce the use of the software, a method to protect the content of the documents against export functions such as cut, copy, save as, print screen as well as text grabber software is needed. To do so, the Document Templates Software uses Microsoft Windows hooks that intercept events (messages, mouse actions, keystrokes). When a content export event is detected, the Document Templates Software will cancel the action and a popup window will inform the user that a paid version license key is required to enable that function.

For each open document, the Document Templates Software verifies if the user has a valid license key. If the client has the required license, he/she will be given the right to use the content export functions such as cut, copy, save as. If not, all attempts to do so will result in a popup window warning the user that a valid license key is required. This popup window provides the user with the option to quickly purchase a license key via a secure https connection and thereby unlock all disabled functions within minutes. The user would simply need to input the key he/she obtains following his/her purchase into a designated “activation” window of the software. Along with enabling all disabled functions, activating the software with such a licence key will also remove all or most of the advertisements in the software or give the user the ability to remove the ads.

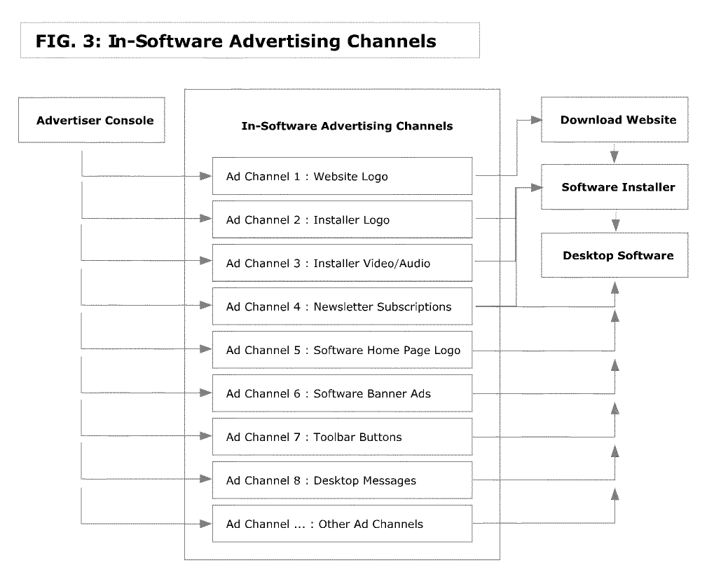

In an evolution of the Document Templates Software, many new and emerging ad technologies can be incorporated into the software, the download website and the installer to provide advertisers with additional channels (FIG. 3) or methods of displaying ads or engaging users in selected content. An example of such a new ad channel can be In-Text Advertising which consists of adding hyperlinks or tags to certain keywords or phrases within documents or other content. Via its Advertiser Console, an advertiser would be able to tag a word and associate it with a hyperlink which will send the user to a desired URL once the word is clicked.

The In-Text Advertising method would provide a small textual and/or graphical window that appears near a word when a user hovers his/her mouse over it. The hyperlink may be implemented inside this window and/or on the word itself.

1. An “In-Software Advertising Platform”, including an “Ad Server”, an “Advertiser Account Console” and a software client component, element, module, API, or “Ad Player” that offers developers and advertisers various advertising channels (ad creative types, formats and targeting options). This Ad Player would allow any software developer to easily add advertisements to a software program in order to monetize the distribution of the application.

2. Method of claim 1, wherein advertisers can access an advertiser console allowing them to create, edit, delete and manage their advertising campaigns. The web-based advertiser console also allows advertisers to view all the statistics related to their campaigns.

3. A computer-implemented advertising platform of claim 1, wherein the various advertising channels available from the Ad Player include but are not limited to: advertiser's logo on the download website, advertiser's logo in the software installer, advertiser's newsletters subscription in the software installer, video or audio ads in the software installer, advertising on the software home page, a toolbar with sponsored actionable buttons, sponsored desktop messages and advertising in at least one predominant area of the interface that surrounds the document or content displayed to the user.

4. Method of claim 1, wherein the Ad Player has the capability to display ads of any size and in various format (text links, banners, video, rich media, audio, request for proposals, surveys, forms, etc.).

5. Method of claim 1, wherein the Ad Player can take the form of a miniature web browser. This web browser could also be able to detect a click event made by the software user. On such an advertisement click event, the mini browser could expand itself to become a full screen browser or trigger the opening of a new tab/window in full screen mode within the software interface.

6. Method of claim 1, wherein an advertiser can sponsor a software application. A software sponsor could have the privilege to have its brand displayed in the software permanently, thus benefiting from lifetime exposure to a specific user without necessarily incurring additional costs in the future. Every time a user runs the software, he/she would be exposed to the same sponsor(s). However, sponsors may not be the same from one user to another. The sponsor's ad is delivered by a web server.

7. Method of claim 6, wherein sponsor's ads are consistently displayed throughout the user experience with potential placements of sponsor's logo including but not limited to, the download website, within the software installer and on the software home page. Once a user comes on the download website, sponsors are assigned to him/her forever. Every time a user revisits the site, he/she will see the same sponsors displayed. When clicking on the download button to start the install process, sponsors ads will be displayed in the software installer and ultimately will be displayed to the user every time the software runs. Optionally, sponsors can be presented to the user as the entities permitting the free distribution of such software.

8. Method of claim 1, wherein the Ad Player can dynamically re-target advertisements during a software usage session based on newly acquired user input data (such as ads reviews or profile changes), user behavior in the software or user interaction or non-interaction with a particular ad or type of ads.

9. Method of claim 1, wherein the Ad Player will automatically rotate or update the advertisements presented to the user at a certain interval of time. The Ad Player will not update the advertisements displayed if no user activity (be it mouse movement or keyboard input) is detected in a determined period of time. Once the user becomes active again, the Ad Player timer will restart and the ads will be updated accordingly. Additionally, if the software screen is not active, the Ad Player will not update the ads. An active screen is defined as a software window being maximized or at least fully visible by the user.

10. Method of claim 9, wherein the Ad Player will dynamically be communicated by the Ad Server how much time each ad should be exposed. If the server ad inventory is high, the ads would be refreshed at a normal interval of time. If the server ad inventory is low, i.e. there is an insufficient amount of ads to fill all the available air-time, the Ad Server could inform the Ad Player to refresh ads at a slower pace (longer exposure for each ad).

11. Method of claim 1, wherein the Ad Player itself or a computer-implemented component, has the capacity to dynamically adjust the advertising display area size according to the users screen resolution or according to the detected “unused” or available screen space. Unused screen space is defined as a screen display area that is not used to present application buttons, menus, functions, data, content or such, but instead offers unexploited space in the software interface, such as plain backgrounds.

12. Method of claim 11, wherein according to the available display space, the Ad Player will request and display the highest paying ads or content from an Ad Server.

13. Method of claim 1, wherein one or many advertisers desire to advertise in a software application that has limited ad space available, an Ad Server algorithm will decide which advertiser will obtain the privilege to present its ad to a specific user. The Ad Server can assign advertising opportunities on a first come first serve basis (until an advertiser's budget is exhausted), proportionally distribute advertising opportunities according to each advertiser's budget or provide advertising placement to the highest paying advertiser.

14. Method of claim 1, wherein an Ad Player is used to display advertising (be it images, html pages, text links, video, audio, surveys, newsletters subscriptions, etc.) in a desktop software installer program to monetize the installation process of any software application.

15. Method of claim 14, wherein a software installer executable can force (or not) the user to listen to, or view, one or more audio/video advertisements during the installation of a software application to monetize the installation process.

16. Method of claim 14, wherein a software installer executable can dynamically estimate the download and installation time required to complete the installation of the software application in order to pass this information to an Ad Player that would request a corresponding amount of video/audio advertisements from an Ad Server in order to fill this user waiting time.

17. Method of claim 1, wherein advertising can be targeted based on the software type or category, software user profile and the properties of a document or content being viewed.

18. Method of claim 17, wherein ads can be targeted according to user profile variables such as: gender, user location, language, job title, industry, company size, etc.

19. Methods, systems and computer application permitting the display of advertisements in a Document Templates Software while a computer user writes, edits or views a digital document. The Document Templates Software thereafter becomes an “Ad-Supported Document Templates Software” which is unique and should be considered as being an integral part of the this invention.

20. Method of claim 19, wherein ads can be targeted according to the topic of a document template or according to specific words found in the content of a document template.

21. Method of claim 19, wherein a digital document can be, it is not limited to, a document template, an e-book, an article, a presentation or a whitepaper.

22. Method of claim 19, wherein the Document Templates Software can take the form of a document template editor or simply be a document viewer.

23. Method of claim 19, wherein features of an office suite such as Microsoft Office, OpenOffice.org or Corel WordPerfect Office are extended to a Document Templates Software via the embedding (or integration) of the office suite program into the Document Templates Software, program, module or application, and more specifically in the case where it would become an “Ad-Supported Document Templates Software” (FIG. 2A).

24. Method of claim 19, wherein a Document Templates Software includes a built-in text processor, spreadsheet and/or presentation builder program, module, component, plug-in or add-on coupled with in-software advertising to expose users to ads while they view or edit digital documents (FIG. 2B).

25. Method of claim 19, wherein the features of a Document Templates Software are extended to an office suite via a software plug-in, add-on module or the like, coupled with in-software advertising to expose users to ads while they view/edit documents (FIG. 2C).

26. Method of claim 19, wherein an office suite program includes a built-in document template module, component, plug-in or add-on coupled with in-software advertising to expose users to ads while they view or edit digital documents (FIG. 2D).

27. Method to attract people to download and install a Document Templates Software by giving for free or selling at a low cost valuable digital content in the form of document templates, whitepapers, e-books, how-to guides and the like.

28. Method of claim 19, wherein the content of a document template is protected by encrypting the source file in a proprietary format that can only be decrypted by the Document Templates Software, thus forcing the use of the Document Templates Software to view, edit or print the content.

29. Method of claim 28, wherein the encryption envelope or shell can contain any file format be it .doc, xls, .txt, .pdf, .ppt, .html, mpeg, .swf, mp3 or other.

30. Method of claim 19, wherein the content of a document template is protected by a security mechanism that blocks access to all document content export functions (copy, cut, save as, export, print, etc.) in order to force the use of a Document Templates Software to open the document templates.

31. The method of claim 19, wherein a Document Templates Software or an office suite program can be offline (e.g. MS Office and Star Office), hybrid (e.g. Microsoft LIVE and Google Docs) or purely online (e.g. Thinkfree, Zoho, and eDeskOnline).

32. Some features and particularities of such a Document Templates Software could include, but are not limited to:
Multi dimensional document navigation
Search by keywords
Browse by document category
Browse by document type
Browse by task (or process)
Document language mapping allowing to instantly find the equivalent document in another language (instant document translation)
Document auto-fill permitting automatic insertion of personal information
Compatible with all file formats (Able to open and export all types of files in formats such as .doc, xls, .ppt, .html, .pdf, .rtf and .txt, etc).
a User can rate a document template quality
User can request a document template
Automated file recovery (in case the software crashes)
User can email a document
User's personal files folder
User can change the software interface language
User can chose from a variety of interface skins
The application can run in the computer system tray for quick launch
Multi-tab document editing
Integrates web browser (Internet Explorer, Firefox, Safari, etc.)
Client/server template library synchronization to automatically update user's library when a template has been updated or added
Auto-update module to automatically update user's Document Templates Software when a new version is available
a Desktop messaging module allowing the delivery of notices to users even when they are not using the Document Templates Software
a Download additional document language libraries
Upgrade to paid version to remove ads
Online software license activation system
Anonymous usage tracking system permitting to collect data helping developers to improve the Document Templates Software
Bug reporting module permitting to report any Document Templates Software problem or error to the developers
Embedding (or integration) of Microsoft Office via an ActiveX or COM object
Embedding (or integration) of OpenOffice via an ActiveX or COM object
Protection of the documents' content by encrypting the source file in a proprietary format that can only be decrypted by the Document Templates Software
Protection of the documents' content by blocking the use of export functions such as cut, copy, save as, print screen as well as text grabber software.

33. The preceding methods of claims 1 to 18 can be used as part of any in-software advertising application, module, component, system or platform. This system could be used privately by a software provider, be offered as a web service by an application service provider (ASP) or by a software advertising network.
